(19) United States
(12) Patent Application Publication
(10) Pub. No.: US 2012/0124927 A1
(43) Pub. Date: May 24, 2012

(54) Foam injected wall panel

(76) Inventor: Ron Roy Hastings, Prescott, AZ (US)

(21) Appl. No.: 12/927,639

(22) Filed: Nov. 19, 2010

(51) Int. Cl. E04C 2/22; B23P 17/04; E04C 3/07; E04C 2/30; E04C 2/20

(52) U.S. Cl. 52/309.6; 52/309.11; 52/309.7; 52/846; 29/428

(57) ABSTRACT

A structural element (10). The inventive structural element (10) includes a frame (12) comprised of a plurality of studs (40) arranged in two rows, a first row (40A) disposed along a first side of the frame (12) and a second row (40B) disposed along a second side of the frame (12), and a foam core (18) disposed within the frame (12) between the first and second rows of studs (40). In an preferred embodiment, the studs (40) each include an exterior face (52), at least one interior face (54), at least one hollow interior cell (70), and at least one opening (74) through an interior face (54) adapted to provide access to a cell (70), and the foam (18) is adapted to fill the interior of the frame (12), penetrating within the hollow cells (70) of the studs (40) through the interior face openings (74).

### BACKGROUND OF THE INVENTION

1. Field of the Invention

The present invention relates to construction systems and methods. More specifically, the present invention relates to structural elements for wall panels.

2. Description of the Related Art

Conventional construction techniques for residential homes typically build walls having a wooden frame with drywall or OSB (oriented strand board) coverings or sheathings. Wooden structural elements, however, are prone to warping due to environmental factors and are also susceptible to fire, termites and other insects, and deterioration over time. These issues can be avoided by using steel frames. Metal structural elements, however, conduct temperature much better than wood and therefore cause problems with insulation.

Insulating materials such as fiberglass, cellulose, or foam are often disposed within exterior walls to reduce heat transfer through the walls. These insulation materials are typically placed between studs in the wall frame, but generally are not anchored to the studs. The insulation is thus a “floating surface”, not bonded or attached to the studs or sheathings. Air, water, insects, and animals can therefore penetrate the wall at the seams or joints between the wall components. Furthermore, since the insulation is only between studs, it does not solve the problem of heat transfer across studs, particularly metal studs.

Hence, a need remains in the art for an improved system or method for building walls that are more energy efficient, weather resistant, and insect resistant than conventional walls.

### SUMMARY OF THE INVENTION

The need in the art is addressed by the novel structural element of the present invention. The inventive structural element includes a frame comprised of a plurality of studs arranged in two rows, a first row disposed along a first side of the frame and a second row disposed along a second side of the frame, wherein the second side is opposite the first side, and a foam core disposed within the frame between the first and second rows of studs.

In an preferred embodiment, the studs each include an exterior face, at least one interior face, at least one hollow interior cell, and at least one opening through an interior face for providing access to a hollow interior cell. A first sheathing is attached to the exterior face of the studs in the first row, and a second sheathing is attached to the exterior face of the studs in the second row. The foam is injected such that it fills the interior of the frame, bonding to the first and second sheathings and the studs, and penetrating within the hollow cells of the studs through the interior face openings, thereby forming a single, integrated and structurally stable component.

### BRIEF DESCRIPTION OF THE DRAWINGS

FIG. 1 is a simplified diagram of a foam injected wall panel in accordance with an illustrative embodiment of the present teachings.

FIG. 2 shows a simplified cross-sectional diagram of a portion of a wall panel in accordance with an illustrative embodiment of the present teachings.

FIG. 3 is a simplified diagram of a conventional structural frame.

FIG. 4 is a simplified diagram of a structural frame in accordance with an illustrative embodiment of the present teachings.

FIG. 5 is a simplified diagram of a stud in accordance with an illustrative embodiment of the present teachings.

FIG. 6 is a simplified cross-sectional diagram of a stud in accordance with an illustrative embodiment of the present teachings.

FIG. 7 is a simplified flow diagram of a method for building an injected foam wall panel in accordance with an illustrative embodiment of the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

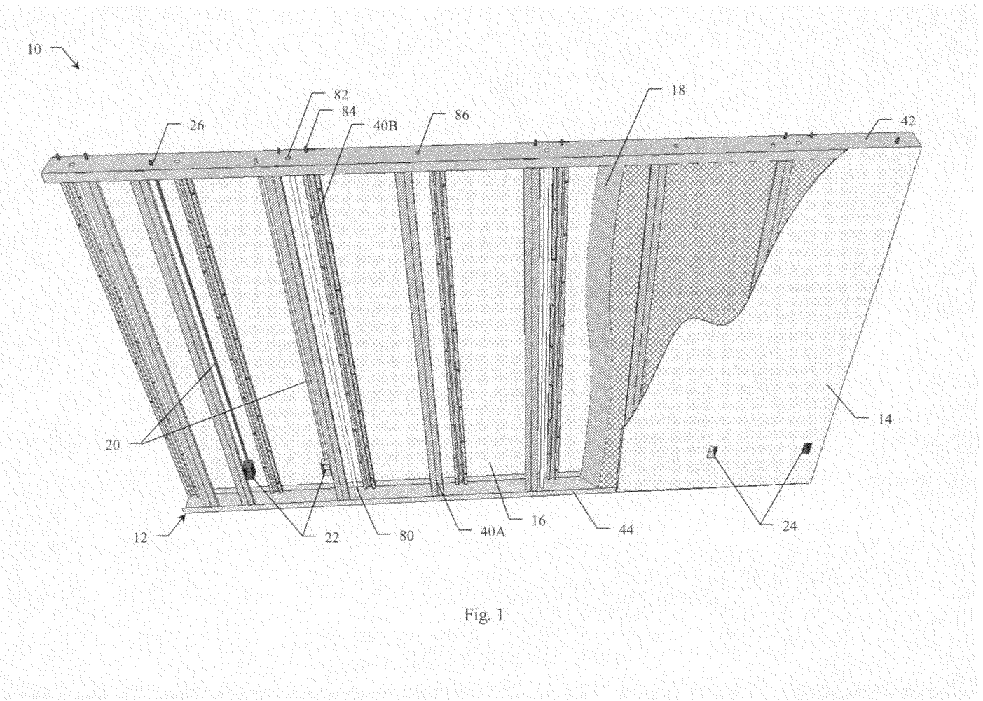

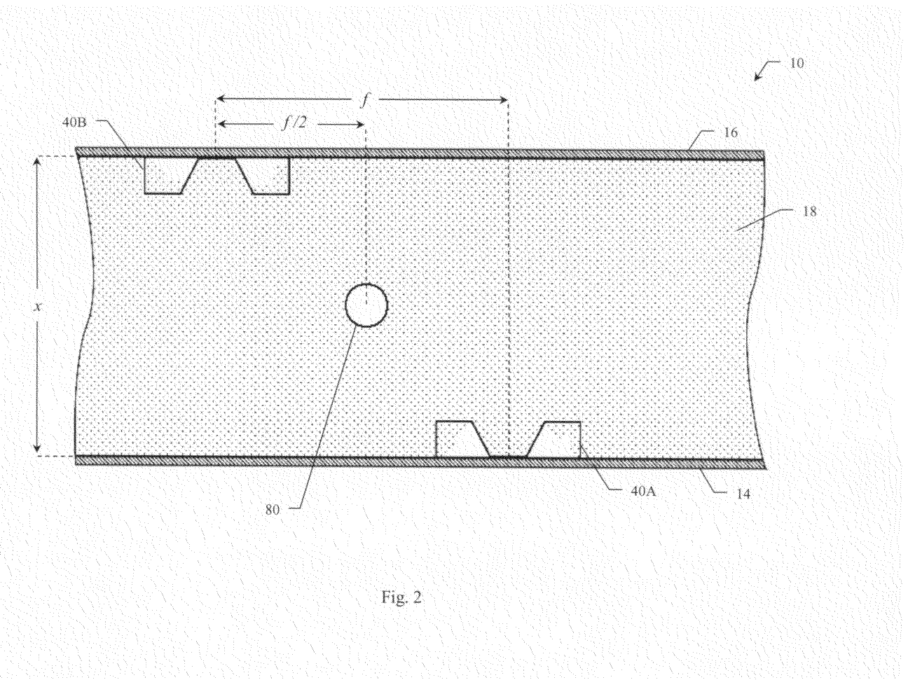

FIG. 1 is a simplified diagram of a foam injected wall panel 10 in accordance with an illustrative embodiment of the present teachings, and FIG. 2 shows a simplified cross-sectional diagram of a portion of the wall panel 10 in accordance with an illustrative embodiment of the present teachings. The present invention provides a novel wall panel 10 comprised of a steel frame 12, first and second sheathings (14 and 16) attached to opposite sides of the frame 12, and an injected foam 18 filling the interior of the wall 10 between the two sheathings 14 and 16 (in FIG. 1, the interior sheathing 14 and the foam 18 are partially cut away to more clearly show the interior of the wall 10).

In accordance with the present teachings, the foam 18 is injected into the interior of the frame 12 as a liquid that expands as a foam to fill every crevice within the wall structure 10. Once the foam sets, it forms a single, seamless, solid foam core 18 that is securely bonded to the frame 12 and sheathings 14 and 16, as well as to any other structures within the wall 10 such as plumbing or electrical components (electrical pipes 20 and boxes 22 are shown in the example of FIG. 1), with an airtight seal. The wall 10 is therefore fireproof, insect resistant, well insulated, and structurally stable.

The foam injected wall panel 10 includes a novel structural frame 12 specially designed for use with the injected foam 18. FIG. 3 is a simplified diagram of a conventional frame 30. A structural frame element 30 typically includes a plurality of studs 32 between a top plate 34 and a bottom plate 36. In most conventional home constructions, the studs 32 are made from wood 2×4's. Wood, however, is a relatively poor material for studs because it usually is not perfectly straight and is susceptible to weather, termites and other insects, and deterioration. The present invention therefore prefers using studs made from steel, which avoids the problems of weather, insects, and deterioration, but adds insulation problems since metal is a better conductor of temperature than wood. Conventional steel frames typically use the same frame design 30 as shown in FIG. 3, in which the studs 32 are oriented transverse to the wall 30 such that one side of the stud 32 is attached to the exterior sheathing while the opposite side of the stud 32 is attached to the interior sheathing. This design causes insulation difficulties when using metal studs 32 since the exterior temperature is conducted to the interior of the wall through the studs 32. The conventional transverse stud design of FIG. 3 would also present difficulties for the injected foam design of the present invention since the studs 32 separate the wall 30 into distinct sections and would block the foam from forming a single, unified foam core across the entire length of the wall as desired by the present teachings.

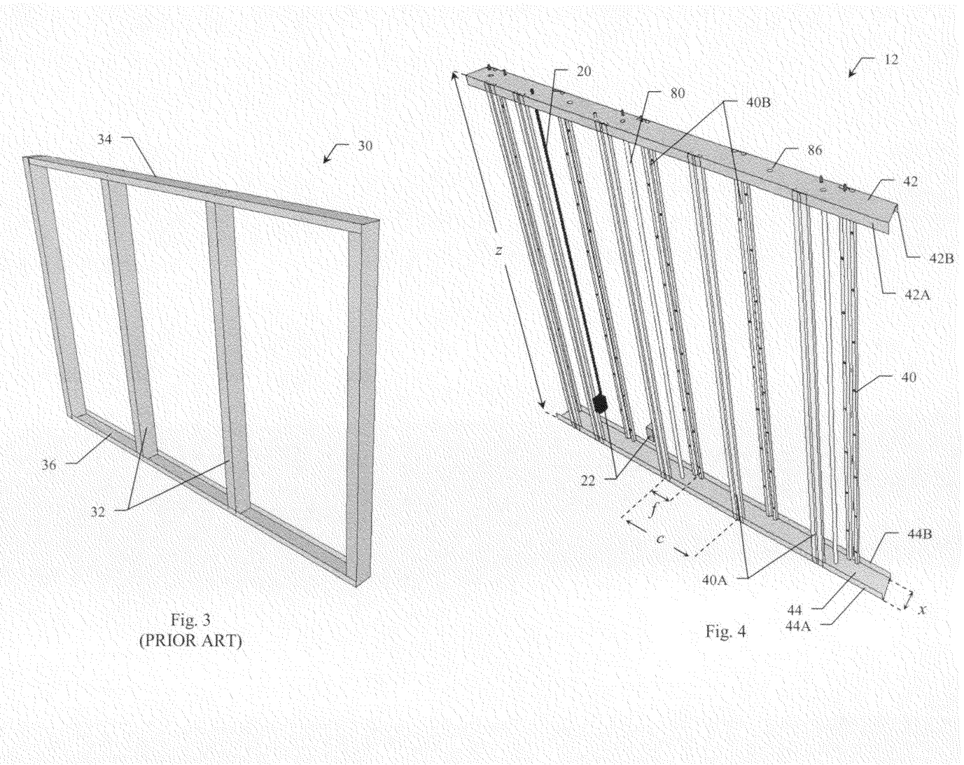

FIG. 4 is a simplified diagram of a structural frame 12 in accordance with an illustrative embodiment of the present teachings. The frame 12 includes a plurality of studs 40 attached between a top plate 42 and a bottom plate 44. In the preferred embodiment, the studs 40 and top and bottom plates 42 and 44 are made from metal, such as 24-gauge steel. In accordance with the present teachings, the studs 40 are oriented along the length of the wall (e.g., along the tracks 42 and 44) instead of across the width of the wall as per conventional practice (as shown in FIG. 3). The frame 12 includes two parallel rows of studs: a first row of studs 40A is attached to a first side 42A and 44A of the top and bottom plates 42 and 44, respectively, and a second row of studs 40B is attached to a second side 42B and 44B of the top and bottom plates 42 and 44, respectively. The first wall sheathing 14 is attached to the first row of studs 40A, while the second wall sheathing 16 is attached to the second row of studs 40B (as shown in FIGS. 1 and 2). The studs 40 are much thinner than the width x of the wall such that studs in the first row 40A are not in contact with studs in the second row 40B or with the second sheathing 16, and studs in the second row 40B are not in contact with studs in the first row 40A or with the first sheathing 14. This design allows the injected foam 18 to fill the entire wall 10 without any barriers, forming a single foam core 18 along the length of the wall. It also avoids the temperature flux problems associated with metal transverse studs.

Insulation can be further improved by offsetting the first and second rows of studs 40A and 40B to increase the distance between studs and thereby reduce any temperature coupling between studs in different rows. In the illustrative embodiment, the studs in the first row 40A are offset from studs in the second row 40B by a distance f=3 inches, and the distance between neighboring studs 40 in the same row is c=2 feet (i.e., 2-feet centers).

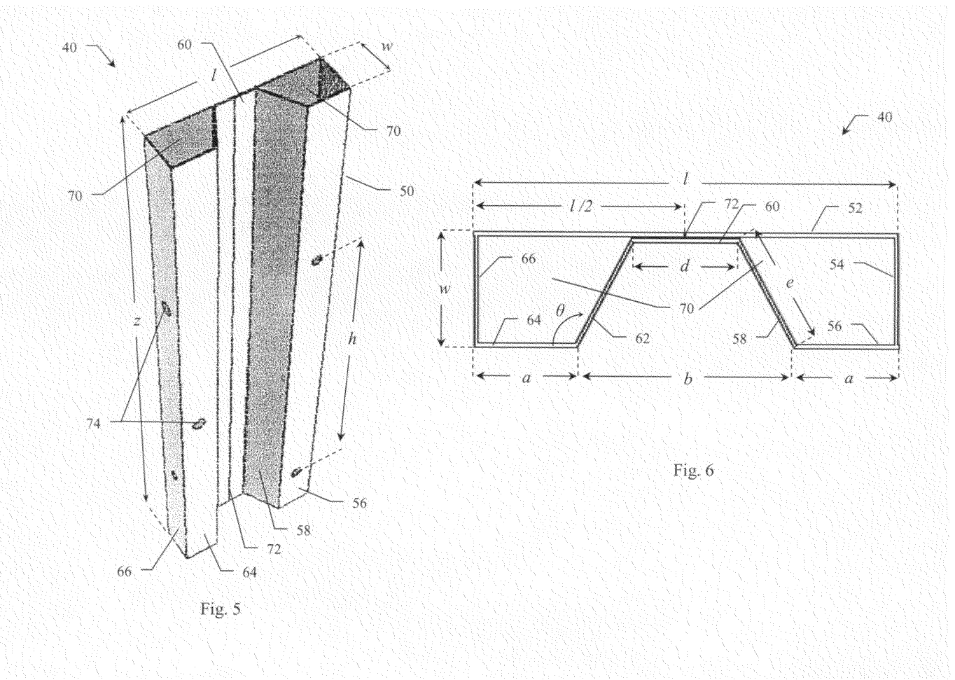

In a preferred embodiment, the studs 40 have a novel size and shape designed for use with the injected foam design of the present teachings. FIG. 5 is a simplified diagram of a single stud 40 in accordance with an illustrative embodiment of the present teachings, and FIG. 6 is a simplified cross-sectional diagram of the novel stud 40. Conventional studs generally have a rectangular cross-section (such as wood 2×4's) or, in the case of metal studs, a U-shaped cross-section. In accordance with the present teachings, the stud 40 is fabricated from sheet metal 50 bent to form an enclosure such that the stud 40 has one or more hollow interior cells. The stud 40 includes an exterior face 52 for attaching the stud 40 to the sheathing, and a plurality of interior faces (54, 56, 58, 60, 62, 64, and 66), which are sides facing the interior of the wall. Some of the interior faces are perforated with a plurality of openings 74 for allowing the injected foam to penetrate into the hollow interior of the stud 40. Thus, after the foam sets, the studs 40 are fully integrated and bonded with the foam core 18, the foam disposed around, through, and within each stud 40. Any loads applied to the wall 10 are distributed through both the studs 40 and the foam core 18.

In the preferred embodiment, the stud 40 is formed to have a “B” shaped cross-section (as shown in FIGS. 5 and 6), having a length l=3″ and a width w=¾″. The stud 40 has the same cross-section throughout the length z of the stud (which is the determined by the desired height of the wall). Going clockwise around the stud 40 as shown in FIG. 6, the stud 40 has a first side 52 of length l=3″, a second side 54 of length w=¾″ perpendicular to the first side 52, a third side 56 of length a=¾″ perpendicular to the second side 54, a fourth side 58 of length e˜ 13/16″ at an angle of about θ=π−tan⁻¹(2)≈117° to the third side 56, a fifth side 60 of length d=¾″ at an angle θ to the fourth side such that the fifth side 60 is parallel and adjacent to the first side 52 at the center of the first side 52, a sixth side 62 of length e at an angle of about θ to the fifth side 60, a seventh side 64 of length a=¾″ at an angle of about θ to the sixth side 62, and an eighth side 66 of length w=¾″ perpendicular to the seventh side 64 and the first side 52. Other dimensions may also be used without departing from the scope of the present teachings. The size of the stud 40 should be large enough to support required loads but thin enough to avoid insulation issues and to allow the foam 18 to penetrate through the entire length of the wall and form a single, seamless core 18. The stud 40 may be much thinner than conventional studs since in the novel wall design of the present invention, the studs 40 do not bear structural loads alone; loads are also distributed across the rigid foam core 18. The exterior stud face 52 should also be large enough to allow attachment to the wall sheathing 14 or 16, and the side surfaces 54 and 66 should be wide enough to allow attachment to any electrical or plumbing components.

Thus, the stud cross-section is bent into a rough “B” shape, forming two symmetrical hollow interior cells 70, which can then be filled with foam. In the preferred embodiment, the hollow regions 70 have a (non-parallelogram) trapezoid shape, which is more stable than a rectangular cell. The two separate hollow cells 70 also provide a much better compression ratio than a conventional solid wooden stud. The stud 40 is preferably formed from 24-gauge sheet metal 50 that is bent or otherwise machined into the desired shape. The stud 40 will have a seam 72 where the edges of the sheet metal 50 meet. In the preferred embodiment, for strength and stability, the seam 72 is located near the center of the exterior face 52 or the center of the central interior face 60. The seam 72 is preferably laser welded along the length z of the stud 40 at intervals of about 6 inches.

The exterior face 52 of the stud 40 is attached at the top and bottom to the top and bottom plates 42 and 44, and to the wall sheathing (14 or 16). The interior faces 54, 56, 64, and 66 are machined with a plurality of openings 74 as described above for allowing the injected foam 18 to penetrate into the interior hollow regions 70 of the stud 40. In the illustrative embodiment, each side 54, 56, 64, and 66 includes openings 74 along the length z of the stud 40 at intervals of about h=6 inches. Openings 74 in the second side 54 are offset from the openings in the adjacent side 56, and openings in the seventh side 66 are offset from the openings in the adjacent side 64. In the preferred embodiment, the interior cells 70 of the stud 40 are completed filled with the foam 18. However, it is not necessary for them to be completely filled; it is sufficient if only some foam penetrates into the interiors 70 through the openings 74 such that the stud 40 is completely integrated with the foam core 18.

Returning to FIGS. 1 and 2, in accordance with the present teachings, any other components within the wall 10 should be positioned as desired prior to injecting the foam 18. In the example of FIG. 1, the wall panel 10 houses some electrical piping 20 and boxes 22. The wall sheathing 14 may include openings 24 for accommodating any electrical boxes 22 and/or plumbing fittings, and the top and/or bottom tracks 42 and 44 may include openings 26 for accommodating plumbing and/or electrical pipes.

The wall panel 10 may also include components for attaching the panel 10 to flooring and/or ceiling or roof structures. In a preferred embodiment, the wall panel 10 includes vertical pipes 80 (such as 1″ PVC pipe, for example) extending between the top plate 42 and bottom plate 44 through openings 82 in the top and bottom plates 42 and 44 for attaching the wall panel 10 to flooring structures (such as reinforcing bars or rebars) and/or roofing structures. The pipes 80 are positioned in the center of the wall 10 between the first and second rows of studs 40A and 40B (pipes 80 are disposed along the length of the wall 10 every 4 feet in the illustrative embodiment). Each pipe 80 is centered between a stud in the first row 40A and a stud in the second row 40B for maximum strength (see FIG. 2, which shows the horizontal distance between a pipe 80 and the nearest stud 40 in either row is ½f, half the row offset). Alternatively, or in addition, the wall panel 10 may include bolts 84 or other fasteners in the top and/or bottom plates 42 and 44 for attaching the wall 10 to flooring and/or roofing structures.

The top plate 42 should also include one or more openings 86 through which the foam 18 is injected. In the illustrative embodiment, the top plate 42 includes an access hole 86 for injecting the foam every 4 feet across the length of the top plate 42.

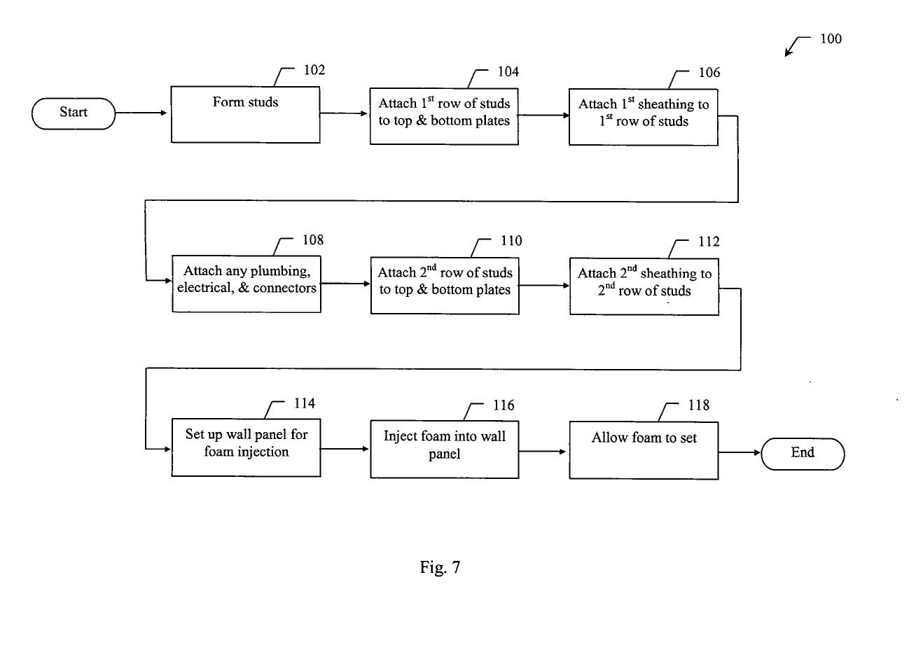

FIG. 7 is a simplified flow diagram of a method 100 for building an injected foam wall panel 10 in accordance with an illustrative embodiment of the present teachings. First, at Step 102, the studs 40 are formed by bending a sheet of steel approximately 8½″ wide to provide a stud with a B-shaped cross-section as described above. In the preferred embodiment, the studs are fabricated from 24-gauge steel; however, other materials including other types of metals, wood, plastics, or composite materials may also be used without departing from the scope of the present teachings. The interior sides of the studs 40 are machined with openings to facilitate the foam injection as described above. The studs 40 may also be pre-drilled with holes for attaching the studs 40 to the top and bottom plates 42 and 44 and/or to the wall sheathings 14 and 16.

Next, at Step 104, the first row of studs 40A is attached to the top and bottom plates 42 and 44. The top plate 42 includes pre-drilled holes in its first and second sides 42A and 42B for attaching the top plate 42 to the studs 40. Similarly, the bottom plate 44 also includes pre-drilled holes in its first and second sides 44A and 44B for attaching the bottom plate 44 to the studs 40. In an illustrative embodiment, the studs 40 are attached to the top and bottom plates 42 and 44 using ½″ modified truss screws. The top plate 42 includes one or more pre-drilled access holes 86 through which the foam will be injected. The top and bottom plates 42 and 44 may also include pre-drilled openings 26 for any plumbing or electrical pipes 20, and/or openings 86 for any connecting mechanisms 80 for attaching the wall panel 10 to any flooring or roofing structures.

At Step 106, the first wall sheathing 14 is attached to the first row of studs 40A. The sheathings 14 and 16 can be any appropriate material for forming a wall surface. Preferably, the sheathing 14, 16 should be made from a material that will bond strongly with the foam 18. In the preferred embodiment, the sheathing 14 is made from ¼″ cement board, which will form a very strong bond with the foam 18 due to its porosity. Since the foam core 18 will provide a solid structural base, the sheathings 14 and 16 do not need to provide any structural support and therefore do not need to be very thick. The sheathings 14 and 16 primarily function to contain the foam 18, and to provide a flat surface for any finish coatings or to attach conventional wall coverings such as stucco or sidings. The thinnest available cement board, which was ¼″ thick, was therefore chosen for the preferred embodiment.

In the illustrative embodiment, a very thin coating of an adhesive such as roofing cement is rolled onto the exterior sides 52 of the studs 40A. The cement board sheathing 14 is then laid horizontally on top of the studs 40A, and attached with ½″ modified truss screws every two feet to each stud 40. In the diagrams, the sheathing 14 has been shown as a single element; however, in practice, the sheathing 14 may be formed from multiple boards. For example, the sheathing 14 may include two rows of ¼″×4′×12′ cement board sheets.

Next, at Step 108, any interior structures (such as electrical or plumbing components) are positioned within the wall assembly 10. In the illustrative method, the wall assembly 10 is flipped 180 degrees top to bottom (so that the attached first sheathing 14 faces downward). Electrical and/or plumbing fixtures are then laid into place in the interior wall void. Any connector components such as the connector pipes 80 described above are also laid in place and/or attached to the top and/or bottom plates 42 and 44.

At Step 110, the second row of studs 40B is attached to the top and bottom plates 42 and 44. Electrical and plumbing components may be secured to one or more studs 40 in the first or second rows 40A or 40B.

At Step 112, the second wall sheathing 16 is attached to the second row of studs 40B. In the preferred embodiment, the sheathing 16 is made from ¼″ cement board. In the illustrative method, a very thin coating of an adhesive such as roofing cement is rolled onto the exterior sides 52 of the studs 40B. The cement board sheathing 16 is then laid horizontally on top of the studs 40B and attached with ½″ modified truss screws every two feet to each stud 40. The sheathings 14 and/or 16 may include pre-cut out openings 24 to accommodate protruding electrical boxes and/or plumbing fittings.

Next, at Step 114, the wall panel 10 is prepared for the foam injection. In the illustrative method, the wall panel 10 is tilted vertical, transferred to a roll platform, and moved to the foam injection mold (which is an expansion containment form). Temporary end caps treated with a layer of oil or other substance for resisting bonding with the foam may be placed on the ends of the wall panel 10.

At Step 115, foam in its liquid state is then injected with a timed volume into the pre-drilled access holes 86 in the top plate 42. The foam expands and fills the interior area of the wall panel 10, between the cement boards 14 and 16 and through and within each stud 40.

In the preferred embodiment, the injected foam 18 is a soy-based, 2 lb. closed cell polyurethane foam such as PF-7300-0 Soya, manufactured by Enviro Foam Insulation International, Inc. Other foams may also be used without departing from the scope of the present teachings. Any injectable foam that can be injected as a liquid, expand as a foam to fill the interior area, and then set forming a strong bond with the wall sheathings and studs and forming a solid, structurally stable core capable of handling any applied loads may be used for this application. The foam should be closed cell, which means that the cell walls or surfaces are completely closed, making the foam airtight and watertight. The foam is preferably made from renewable soybean oil, which is more environmentally friendly than conventional petroleum-based foams such as EPS (expanded polystyrene).

Finally, at Step 118, the foam reacts and sets (approximate time of 5-8 minutes using the preferred type of foam), forming a single solid, seamless, foam core 18 filling the wall interior and bonded to all components of the cement board contained wall, including the studs 40, top and bottom plates 42 and 44, electrical and plumbing components 20 and 22, connectors 80, and sheathings 14 and 16. The assembly and injection process thus produces a unified structure 10 with high thermo insulation values.

The wall panel 10 of the present invention can be used as exterior or interior walls, load-bearing or non-load-bearing. In a preferred embodiment, the entire length of a wall is fabricated as a single panel to minimize any seams or joints between panels. Thus, the only seams would be at the corners of the house, where adjacent wall panels meet. Adjacent wall panels may be attached using metal brackets or similar connectors. The novel panels 10 may also be modified for use as flooring, ceiling, or roofing panels.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

Accordingly,

What is claimed is:

1. A structural element comprising:
a frame including a plurality of studs arranged in two rows, a first row disposed along a first side of said frame and a second row disposed along a second side of said frame, wherein said second side is opposite said first side, and
a foam core disposed within said frame between said first and second rows of studs.

2. The invention of claim 1 wherein said studs and said foam core are adapted to bear loads applied to said element.

3. The invention of claim 1 wherein said studs each have a thickness less than a distance between said first and second rows.

4. The invention of claim 1 wherein said first row of studs is offset from said second row of studs.

5. The invention of claim 1 wherein said studs each include an exterior face, at least one interior face, and at least one opening through an interior face.

6. The invention of claim 5 wherein said foam fills an interior of said frame between said first and second rows and through said interior face openings in each stud.

7. The invention of claim 5 wherein each stud further includes at least one hollow interior cell, and each interior face opening is adapted to provide access to a cell.

8. The invention of claim 7 wherein said foam fills an interior of said frame between said first and second rows and penetrates within said hollow interior cells of said studs through said interior face openings.

9. The invention of claim 7 wherein each stud includes two symmetrical hollow interior cells.

10. The invention of claim 7 wherein said hollow interior cells have a trapezoidal cross-section.

11. The invention of claim 7 wherein said studs have a B-shaped cross-section.

12. The invention of claim 7 wherein said studs are fabricated from sheet metal bent into an enclosed shape.

13. The invention of claim 1 wherein said studs are fabricated from steel.

14. The invention of claim 7 wherein said element further includes a first sheathing attached to the exterior face of each stud of said first row and a second sheathing attached to the exterior face of each stud of said second row.

15. The invention of claim 14 wherein said first and second sheathings are made from cement board.

16. The invention of claim 14 wherein said foam is bonded to said first and second sheathings and each said stud.

17. The invention of claim 14 wherein said foam forms a seamless core filling an interior of said frame between said first and second sheathings and within and through said studs.

18. The invention of claim 1 wherein said foam is closed cell.

19. The invention of claim 1 wherein said foam is a soy-based polyurethane.

20. The invention of claim 1 wherein said frame further includes a top plate and a bottom plate, and said studs are attached between said top and bottom plates.

21. The invention of claim 20 wherein said top plate includes at least one access hole for injecting said foam into said frame.

22. The invention of claim 20 wherein said element further includes at least one pipe embedded within said foam core and coupled to said top and bottom plates, and adapted to connect said element to a flooring and/or ceiling structure.

23. A structural element comprising:
a top plate;
a bottom plate; and
a plurality of studs disposed between said top and bottom plates, wherein said studs are arranged in two rows, a first row attached to a first side of said top plate and a second row attached to a second side of said top plate, wherein said second side is opposite said first side.

24. A structural element comprising:
a frame including a plurality of studs, wherein each stud includes an exterior face, at least one interior face, and at least one opening through an interior face; and
a foam core filling an interior of said frame and through each interior face opening in each stud.

25. The invention of claim 24 wherein each stud further includes at least one hollow interior cell, and each interior face opening is adapted to provide access to a cell.

26. The invention of claim 25 wherein said foam fills said interior of said frame and penetrates within said hollow interior cells of said studs through said interior face openings.

27. The invention of claim 26 wherein each stud includes two symmetrical hollow interior cells.

28. The invention of claim 26 wherein said hollow interior cells have a trapezoidal cross-section.

29. The invention of claim 24 wherein said studs have a B-shaped cross-section.

30. A structural element comprising:
a frame including a plurality of studs, wherein said studs are arranged in two rows, a first row along a first side of said frame and a second row along a second side of said frame, wherein said second side is opposite said first side, and wherein each stud includes an exterior face, at least one interior face, at least one hollow interior cell, and at least one opening through an interior face of said stud providing access to said hollow interior cell;
a first sheathing attached to the exterior faces of said studs in said first row;
a second sheathing attached to the exterior faces of said studs in said second row; and
a foam filling an interior of said frame between said first and second sheathings and penetrating within said hollow interior cells of said studs through said interior face openings.

31. A stud comprising:
an exterior face;
at least one interior face wherein said exterior and interior faces form at least one hollow interior cell; and
at least one opening within an interior face providing access to said hollow interior cell.

32. The invention of claim 31 wherein said exterior and interior faces form two symmetrical hollow cells.

33. The invention of claim 31 wherein said hollow cells have a trapezoidal cross-section.

34. The invention of claim 31 wherein said stud has a B-shaped cross-section formed by said exterior and interior faces.

35. The invention of claim 31 wherein said stud is fabricated from a single sheet of metal bent into an enclosed shape.

36. The invention of claim 31 wherein said stud is fabricated from steel.

37. A method for constructing a structural element including the steps of:
building a frame comprised of a plurality of studs arranged in two rows, a first row disposed along a first side of said frame and a second row disposed along a second side of said frame, wherein said second side is opposite said first side;
attaching a first sheathing to said first row of studs;
attaching a second sheathing to said second row of studs; and
injecting a liquid foam into an interior of said frame between said first and second sheathings, wherein said liquid foam is adapted to expand as a foam and fill said interior of said frame, bonding to said first and second sheathings and said studs.

38. A method for constructing a structural element including the steps of:
forming a plurality of studs, wherein each stud includes an exterior face, at least one interior face, at least one hollow interior cell, and at least one opening through an interior face of said stud providing access to said hollow interior cell;
building a frame comprised of a plurality of said studs;
attaching a first sheathing to a first side of said frame;
attaching a second sheathing to a second side of said frame, wherein said second side is opposite said first side; and
injecting a liquid foam into an interior of said frame between said first and second sheathings, wherein said liquid foam is adapted to expand as a foam and fill said interior of said frame, penetrating within said hollow cells of each stud through said interior face openings.
